(19) United States
(12) Patent Application Publication
(10) Pub. No.: US 2008/0094540 A1
(43) Pub. Date: Apr. 24, 2008

(54) LIQUID CRYSTAL DISPLAY DEVICE

(76) Inventors: Wee-joon Jeong, Seoul (KR); Jin-soo Shin, Cheonan-si (KR)

Correspondence Address: F. CHAU & ASSOCIATES, LLC, 130 WOODBURY ROAD, WOODBURY, NY, 11797, US

(21) Appl. No.: 11/877,783

(22) Filed: Oct. 24, 2007

(30) Foreign Application Priority Data
Oct. 24, 2006 (KR) 10-2006-0103680

(51) Int. Cl. G02F 1/1335

(52) U.S. Cl. 349/65

(57) ABSTRACT

A liquid crystal display device includes a liquid crystal display panel; a light source part disposed behind the liquid crystal display panel and including a plurality of lamps disposed parallel with each other; and a side mold including an accommodating mold to accommodate an end portion of the light source part and a protrusive reflecting part disposed between the adjacent lamps and protruded toward the liquid crystal display panel.

### CROSS-REFERENCE TO RELATED APPLICATION

This application claims priority to Korean Patent Application No. 2006-0103680, filed on Oct. 24, 2006, in the Korean Intellectual Property Office, the disclosure of which is incorporated herein by reference.

### BACKGROUND OF INVENTION

1. Technical Field

The present disclosure relates to a liquid crystal display device having uniform brightness.

2. Discussion of the Related Art

A flat panel display device such as a liquid crystal display (LCD) device, a plasma display panel (PDP) or an organic light emitting diode (OLED) has been commonly used.

The LCD device includes an LCD panel. The LCD panel includes a first substrate where thin film transistors (TFTs) are formed, a second substrate facing the first substrate and a liquid crystal layer disposed between the substrates. Since the LCD panel is not a self-emissive device, a backlight unit is provided behind the first substrate to provide light. Transmittance of the light supplied from the backlight unit is adjusted in response to an arrangement of liquid crystals.

The backlight unit may be an edge type or a direct type according to a position of a light source.

In the direct type backlight unit, a plurality of light sources are disposed behind the LCD panel to cover an entire area of the LCD panel. The direct type backlight unit provides higher brightness, and thus it is used for a large-screen LCD device.

A lamp is widely used as a light source for the direct type backlight unit. However, an end portion of the lamp is low in brightness as compared with a center portion thereof, and accordingly brightness of the LCD device becomes non-uniform.

### SUMMARY OF THE INVENTION

Embodiments of the present invention provide an LCD device in which brightness is uniform.

In an exemplary embodiment of the present invention, a liquid crystal display device comprises a liquid crystal display panel; a light source part disposed behind the liquid crystal display panel and including a plurality of lamps disposed parallel with each other; and a side mold including an accommodating mold to accommodate an end portion of the light source part and a protrusive reflecting part disposed between the adjacent lamps and protruded toward the liquid crystal display panel.

According to an exemplary embodiment of the present invention, the protrusive reflecting part faces a portion of the lamps.

According to an exemplary embodiment of the present invention, a length of the protrusive reflecting part in a lengthwise direction of the lamps is about 5 mm to about 20 mm.

According to an exemplary embodiment of the present invention, a length of the protrusive reflecting part in a transverse direction to the lengthwise direction of the lamps is about 85% to about 95% of an interval between the adjacent lamps.

According to an exemplary embodiment of the present invention, a height of the protrusive reflecting part is about 26% to about 30% of the interval between the adjacent lamps.

According to an exemplary embodiment of the present invention, the lamps are disposed in a position between about 20% and about 50% of the height of the protrusive reflecting part.

According to an exemplary embodiment of the present invention, a cross section of the protrusive reflecting part in the transverse direction to the lengthwise direction of the lamps is bisymmetric.

According to an exemplary embodiment of the invention, the cross section of the protrusive reflecting part in the transverse direction to the lengthwise direction of the lamps has an isosceles triangle shape.

According to an exemplary embodiment of the invention, the cross section of the protrusive reflecting part in the transverse direction to the lengthwise direction of the lamps has a trapezoid shape.

According to an exemplary embodiment of the present invention, the side mold comprises poly carbonate.

According to an exemplary embodiment of the present invention, a height of the protrusive reflecting part decreases as a distance from the accommodating mold increases.

According to an exemplary embodiment of the present invention, a length of the protrusive reflecting part in a transverse direction to the lengthwise direction of the lamps decreases as a distance from the accommodating mold increases.

In an exemplary embodiment of the present invention, a liquid crystal display device comprises a liquid crystal display panel; a light source part disposed behind the liquid crystal display panel and including a plurality of lamps disposed parallel with each other; an accommodating mold to accommodate an end portion of the light source part; and a protrusive reflecting part disposed adjacent to the accommodating mold, the protrusive reflecting part being disposed between the adjacent lamps, protruding toward the liquid crystal display panel and facing a portion of the lamps.

According to an exemplary embodiment of the present invention, the accommodating mold and the protrusive reflecting part are integrated in a single body.

According to an exemplary embodiment of the present invention, a length of the protrusive reflecting part in a lengthwise direction of the lamps is about 5 mm to about 20 mm.

According to an exemplary embodiment of the present invention, a length of the protrusive reflecting part in a transverse direction to the lengthwise direction of the lamps is about 85% to about 95% of an interval between the adjacent lamps.

According to an exemplary embodiment of the present invention, a height of the protrusive reflecting part is about 26% to about 30% of the interval between the adjacent lamps.

According to an exemplary embodiment of the present invention, the lamps are disposed in a position between about 20% and about 50% of the height of the protrusive reflecting part.

According to an exemplary embodiment of the present invention, a cross section of the protrusive reflecting part in the transverse direction to the lengthwise direction of the lamps is bisymmetric.

According to an exemplary embodiment of the present invention, the cross section of the protrusive reflecting part in the transverse direction to the lengthwise direction of the lamps has an isosceles triangle shape.

### BRIEF DESCRIPTION OF THE DRAWINGS

Exemplary embodiments of the present invention can be understood in more detail from the following descriptions taken in conjunction with the accompanying drawings, in which:

FIG. 1 is an exploded perspective view of an LCD device according to an exemplary embodiment of the present invention;

FIG. 2 is a perspective view of a main part of the LCD device according to an exemplary embodiment of the present invention;

FIG. 3 is a cross-sectional view taken along line III-III in FIG. 2;

FIG. 4 is a cross-sectional view taken along line IV-IV in FIG. 3;

FIGS. 5 and 6 illustrate the flow of light in the LCD device according to an exemplary embodiment of the present invention;

FIG. 7 illustrates brightness distribution according to the shape of a protrusive reflecting part;

FIG. 8 is an exploded perspective view of a main part of an LCD device according to an exemplary embodiment of the present invention;

FIGS. 9 and 10 are cross-sectional views of an LCD device according to an exemplary embodiment of the present invention;

FIG. 11 is a perspective view of a main part of an LCD device according to an exemplary embodiment of the present invention; and

FIGS. 12 and 13 are exploded perspective views of a main part of an LCD device according to an exemplary embodiment of the present invention.

### DESCRIPTION OF THE EXEMPLARY EMBODIMENTS

Exemplary embodiments of the present invention are described more fully hereinafter with reference to the accompanying drawings, in which exemplary embodiments of the invention are shown. This invention may, however, be embodied in many different forms and should not be construed as limited to the embodiments set forth herein.

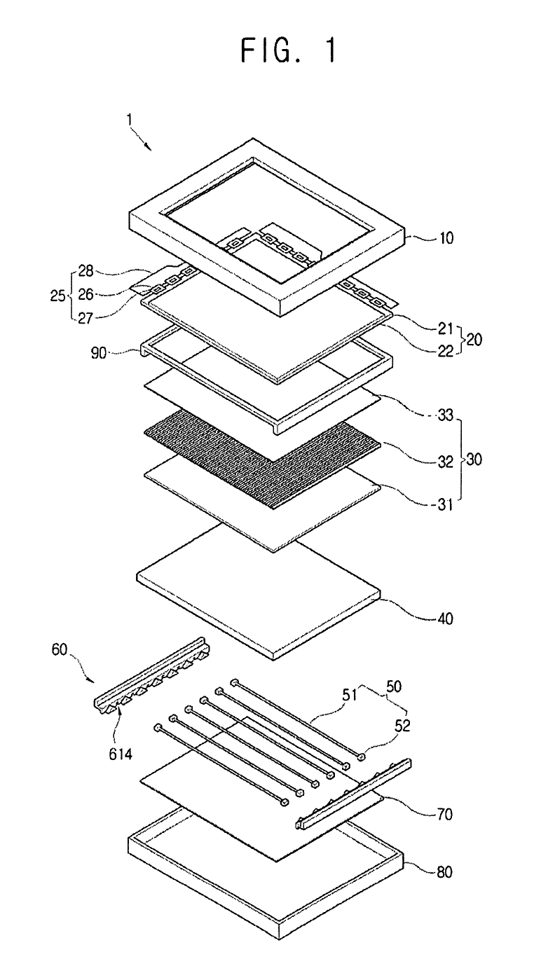

Referring to FIGS. 1 to 4, a liquid crystal display (LCD) device 1 includes an LCD panel 20, an optical film 30 disposed behind the LCD panel 20, a diffusion plate 40 disposed behind the optical film 30, a lamp 50 disposed behind the diffusion plate 40 and a reflection plate 70 disposed behind the lamp 50. The LCD panel 20 is disposed on a panel supporting mold 90.

The foregoing components are accommodated between an upper cover 10 and a lower cover 80. End portions of the lamp 50 are supported by a side mold 60.

The LCD panel 20 includes a first substrate 21 where thin film transistors (TFTs) are formed and a second substrate 22 facing the first substrate 21. A liquid crystal layer (not shown) is disposed between the substrates 21 and 22. The LCD panel 20 displays an image by adjusting an arrangement of liquid crystal molecules in the liquid crystal layer. However, since the LCD panel 20 is not a self-emissive device, the lamp 50 is disposed behind the LCD panel 20 to provide light thereto.

A driver 25 is provided at one side of the first substrate 21 to apply a driving signal. The driver 25 includes a flexible printed circuit board (FPCB) 26, a driver chip 27 disposed on the FPCB 26 and a printed circuit board (PCB) 28 connected to one side of the FPCB 26. The driver 25 shown in FIG. 1 is a chip on film (COF) type. In an embodiment, other types of drivers may be used, for example, a tape carrier package (TCP) type or a chip on glass (COG) type. In addition, the driver 25 may be formed directly on the first substrate 21.

The optical film 30 disposed behind the LCD panel 20 includes a diffusion film 31, a prism film 32 and/or a protection film 33.

The diffusion film 31 diffuses light incident through the diffusion plate 40 and prevents a bright line due to the lamp 50.

The prism film 32 includes triangular prisms formed in a predetermined arrangement thereon. The prism film 32 collects the light diffused in the diffusion film 31 perpendicularly with respect to a surface of the LCD panel 20. In an embodiment, two prism films 32 are used. Micro prisms formed on each of the prism films 32 make a predetermined angle with each other. Most of the light passing through the prism film 32 progresses perpendicularly, thereby forming a uniform brightness distribution.

The protection film 33 disposed at the top of the optical member 30 protects the prism film 32, which is vulnerable to scratching.

The diffusion plate 40 disposed behind the diffusion film 31 may include, for example, polyethylene terephthalate (PET) or poly carbonate (PC). The diffusion plate 40 may include diffusing agents scattered therein or a diffusing agent layer coated thereon. The diffusion plate 40 is thick to have comparatively high intensity, and thus a gap between the diffusion plate 40 and the reflection plate 70 may be kept comparatively regular.

The LCD device 1 may further include a supporter (not shown) to maintain the gap between the diffusion plate 40 and the reflection plate 70.

In an exemplary embodiment, a plurality of lamps 50 are provided and extend lengthwise in a first direction. The lamps 50 are disposed parallel with each other. The lamps 50 are disposed throughout an entire rear of the LCD panel 20. The lamps 50 include a lamp body 51 and an electrode supporting part 52 disposed at each of end portions of the lamp body 51. The lamp supporting part 52 includes a lamp electrode (not shown) therein.

An interval between the lamps 50, a diameter of the lamps 50 and a height thereof refer to an interval between the lamp body 51, a diameter of the lamp body 51 and a height thereof, respectively.

The lamps 50 may include, for example, a cold cathode fluorescent lamp (CCFL) or an external electrode fluorescent lamp (EEFL). The electrode supporting part 52 which is an end portion of the lamp 50 is accommodated in the side mold 60.

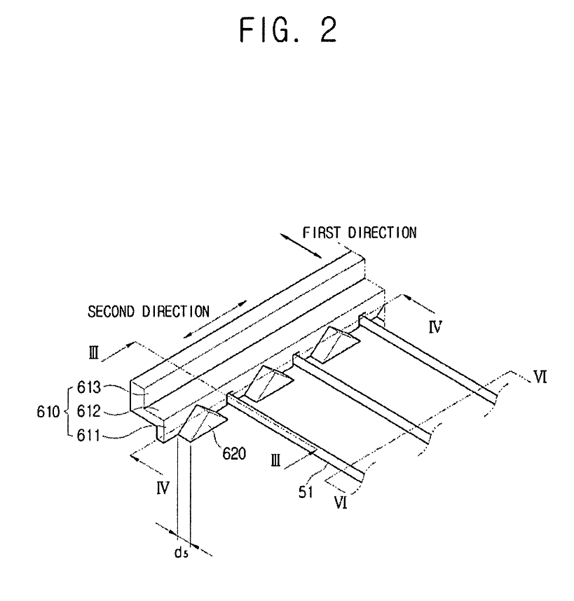

Referring to FIG. 2, the side mold 60 includes an accommodating mold 610 which accommodates the electrode supporting part 52 and a protrusive reflecting part 620 disposed between the lamp bodies 51. The side mold 60 may include poly carbonate, and be formed by an injection molding process.

The accommodating mold 610 includes a reflecting surface 611 disposed in a perpendicular direction to the LCD panel 20, a seating part 612 bent from the reflecting surface 611 and extending parallel with the LCD panel 20, and a supporting part 613 bent from the seating part 612 and protruding upwardly.

An inserting hole 614 is formed in the reflecting surface 611.

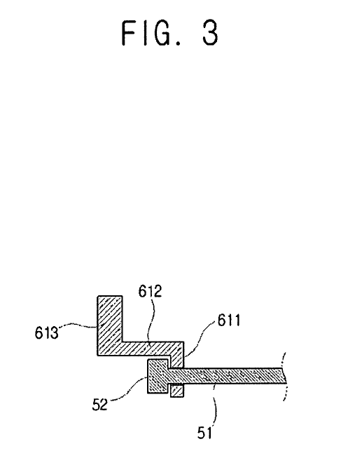

Referring to FIG. 3, the electrode supporting part 52 is disposed inside the side mold 60 through the inserting hole 614. Substantially no portion of the lamp body 51 is disposed inside the inserting hole 614. The reflecting surface 611 reflects light incident from the lamp 50. The reflecting surface 611 may include a reflecting layer coated thereon to improve reflectance.

Opposite sides of the diffusion plate 40 are seated on the seating part 612. The diffusion plate 40 is comparatively thick to be prevented from being transformed and supports the optical film 30.

The supporting part 613 prevents the LCD panel 20 from moving along a surface direction.

In an embodiment, the side mold 60 may not include the supporting part 613. In addition, a cross section of the side mold may be shaped like an upside-down U.

The protrusive reflecting part 620 protrudes from the reflecting surface 611. The protrusive reflecting part 620 is disposed between the adjacent lamps 50, and a lower surface thereof is in contact with the reflection plate 70.

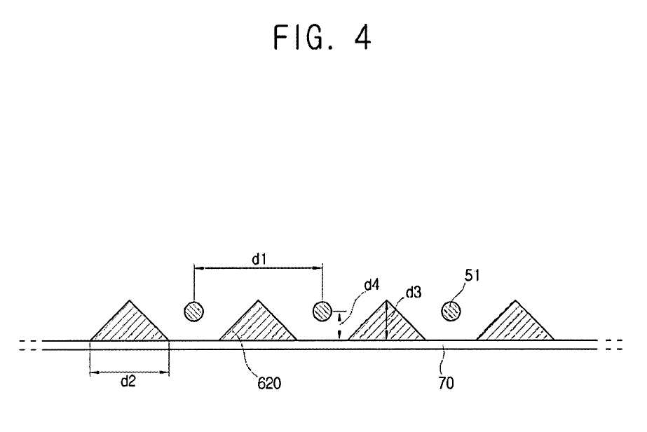

Referring to FIG. 4, a cross section of the protrusive reflecting part 620 is an isosceles triangle shape in a second direction which is a perpendicular direction to an extending direction of the lamp 50. A surface of the protrusive reflecting part 620 facing the lamp 50 may be coated with a reflecting layer to improve reflectance.

The length d2 of the bottom side of the protrusive reflecting part 620 is about 85% to about 95% of the interval d1 between the adjacent lamps 50, and the height d3 of the protrusive reflecting part 620 is about 26% to about 30% thereof. The height d4 from the reflection plate 70 to the center of the lamp 50 is about 20% to about 50% of the height d3 of the protrusive reflecting part 620. The diameter of the lamp 50 is about 3 mm.

Referring to FIG. 3, the majority of the lamp body 51 is not accommodated in the accommodating mold 610. A portion of the lamp body 51 which is adjacent to the lamp electrode is very low in brightness as compared with some other portions. The portion adjacent the lamp electrode may be about 7 mm long.

The protrusive reflecting part 620 according to an exemplary embodiment of the present invention improves the brightness of the portion adjacent to the lamp electrode, and the width d5 (see FIG. 2) of the protrusive reflecting part 620 in the first direction may be about 5 mm to about 20 mm.

The reflection plate 70 is disposed under the lamp 50 and reflects light incident to the diffusion plate 40. The reflection plate 70 may include, for example, plastic such as polyethylene terephthalate (PET) or poly carbonate (PC).

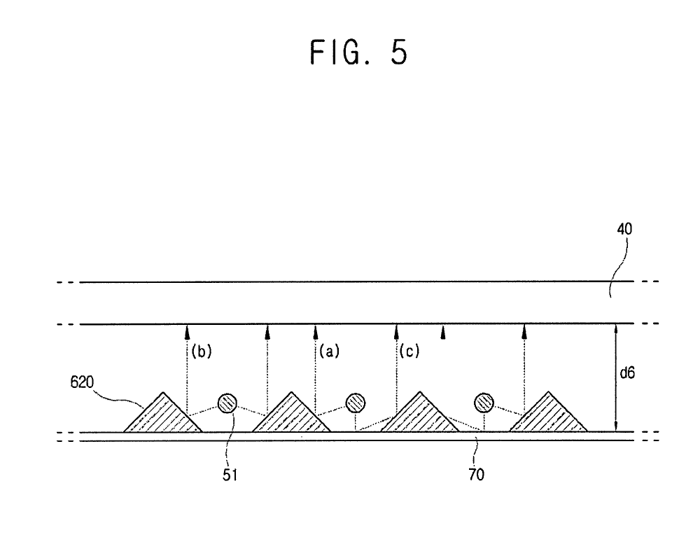

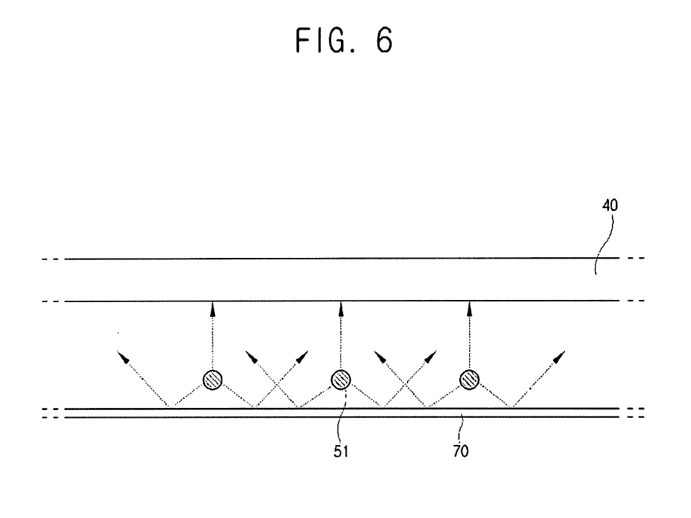

FIGS. 5 and 6 illustrate the flow of light in the LCD device according to an exemplary embodiment of the present invention. FIG. 5 is a cross-sectional view of FIG. 2 taken along line IV-IV; and FIG. 6 is a cross-sectional view of FIG. 2 taken along line VI-VI.

An end portion of the lamp body 51 is positioned close to the lamp electrode. The end portion of the lamp body 51 is low in brightness as compared with the center portion thereof. In addition, the center portion of the lamp body 51 is provided with light from opposite sides of the lamp body 51, while the end portion thereof is provided with light from one side. Thus, a display screen corresponding to the end portion of the lamp body 51 is low in brightness, which is solved by the protrusive reflecting part 620.

Referring to FIGS. 5 and 6, the lamp body 51 emits light uniformly overall, i.e., the light from the lamp body 51 does not have directivity.

Referring to FIG. 5, some of the light “a” from the lamp body 51 is incident directly to the diffusion plate 40. Some of the light “b” from the lamp 51 is incident directly to the protrusive reflecting part 620. Some of the light “c” from the lamp body 51 is incident to the reflection plate 70, and then to the diffusion plate 40 or the protrusive reflecting part 620. The light incident to the protrusive reflecting part 620 is mostly reflected and provided to the diffusion plate 40. Thus, most light generated from the end portion of the lamp body 51 is incident to a corresponding edge area of the diffusion plate 40.

Without the protrusive reflecting part 620, a considerable amount of the light generated from the end portion of the lamp body 51 is delivered to the center portion of the diffusion plate 40, and thus less light is incident to the diffusion plate 40 corresponding to the lamp body 51.

Referring to FIG. 6, a relatively large amount of light is generated in the center portion of the lamp body 51. However, the light is dispersed in various courses.

According to an embodiment of the present invention, an area of the display screen corresponding to the end portion of the lamp body 51 is improved in brightness, and accordingly the overall display screen has uniform brightness.

Brightness distribution of the display screen is influenced by the shape of the protrusive reflecting part 620.

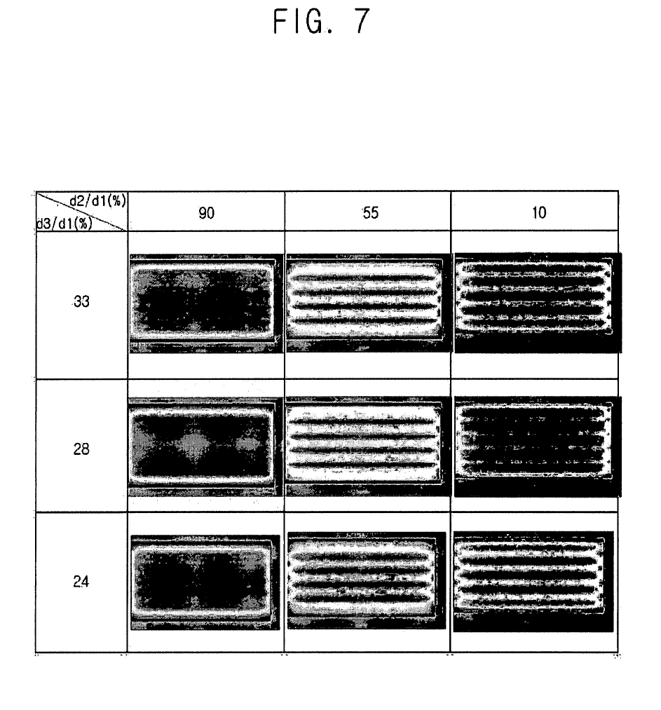

FIG. 7 shows brightness distributions obtained from simulations of various shapes of the protrusive reflecting part 620, e.g., various widths d2 and heights d3.

A percentage of the width d2 of the protrusive reflecting part 620 to the interval between the lamps 50 changes to 10%, 55% and 90%, and a percentage of the height d3 of the protrusive reflecting part 620 to the interval d1 between the lamps 50 changes to 24%, 28% and 33%, respectively. In the simulations, an interval d6 (referred to FIG. 5) between the reflection plate 70 and the diffusion plate 40 is set to be about 45% of the interval d1 between the lamps 50.

Referring to FIG. 7, the brightness distribution is influenced considerably by the percentage of d2 to d1. When the percentage of d2/d1 is small, bright lines are recognized according to the arrangement of the lamps 50 and brightness difference is substantially high between the center portion of the lamp 50 and the end portion thereof.

When the percentage of d2 to d1 is 90%, the brightness distribution becomes uniform. The brightness distribution is mostly uniform when the percentage of d3 to d1 is about 28%. Thus, the percentage of d2 to d1 may be in a range of about 85% to about 95%, and the percentage of d3 to d1 may be in a range of about 26% to about 30%.

When the protrusive reflecting part 620 is manufactured to have about 90% of d2 to d1 and about 28% of d3 to d1, the brightness distribution becomes uniform.

In the simulations, the brightness is measured at nine points of the display screen, and brightness uniformity, i.e., the highest brightness at the nine points/the lowest brightness thereon ×100, is calculated. As a result, the brightness uniformity in the LCD device with the protrusive reflecting part 620 is 84.6%, and the brightness uniformity in the LCD device without the protrusive reflecting part 620 is 81.3%.

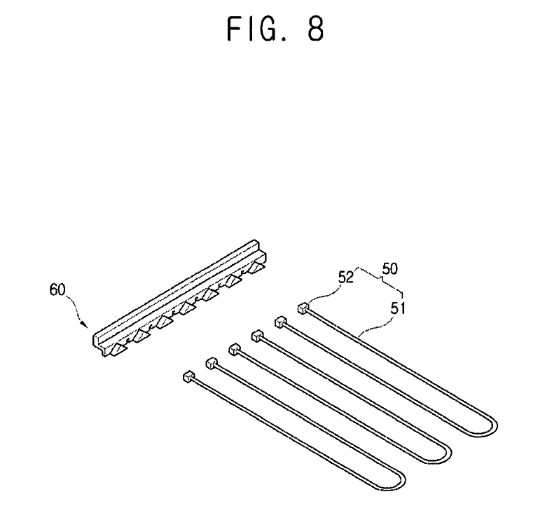

Referring to FIG. 8, the lamp 50 is U-shaped, and the electrode supporting part 52 thereof is disposed at its one side. Thus, the side mold 60 is disposed only at one side where the electrode supporting part 52 is disposed.

The cross-section of the protrusive reflecting part 620 has an isosceles triangle shape. In alternative embodiments, the cross-section of the protrusive reflecting part 620 may have various shapes.

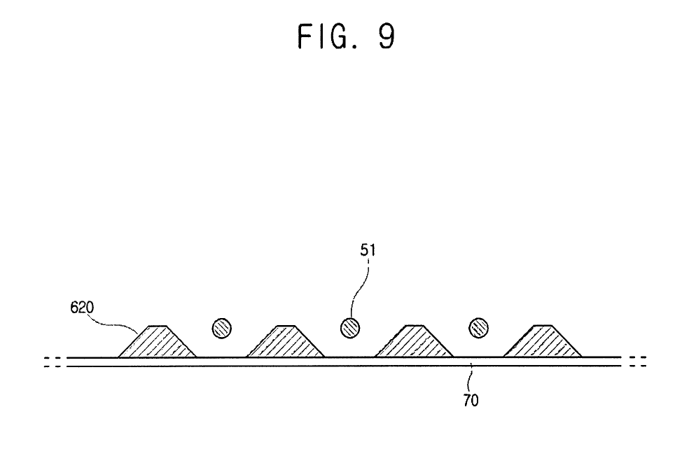

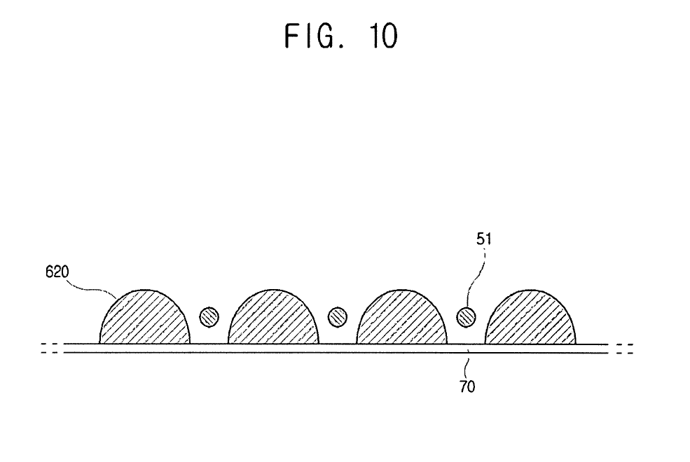

FIGS. 9 and 10 are cross-sectional views taken along line IV-IV in FIG. 3.

Referring to FIG. 9, the protrusive reflecting part 620 has a trapezoid cross-section.

Referring to FIG. 10, the protrusive reflecting part 620 has a curvilinear cross-section.

In alternative embodiments, the protrusive reflecting part 620 may have various shapes and sizes.

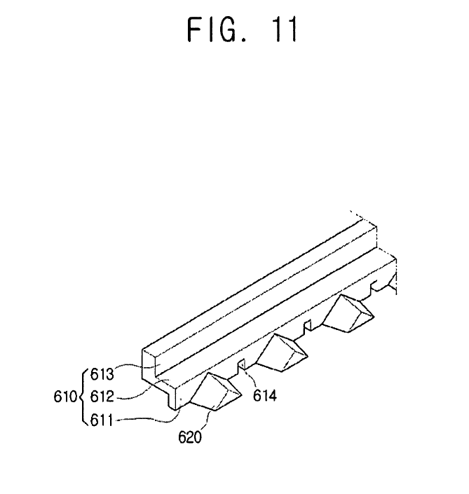

Referring to FIG. 11, the protrusive reflecting part 620 has a shape of an isosceles triangle of which the length of the bottom side and the height decrease as a distance from an accommodating mold 610 increases. According to an exemplary embodiment of the present invention, brightness changes may be reduced at the end portion of the protrusive reflecting part 620.

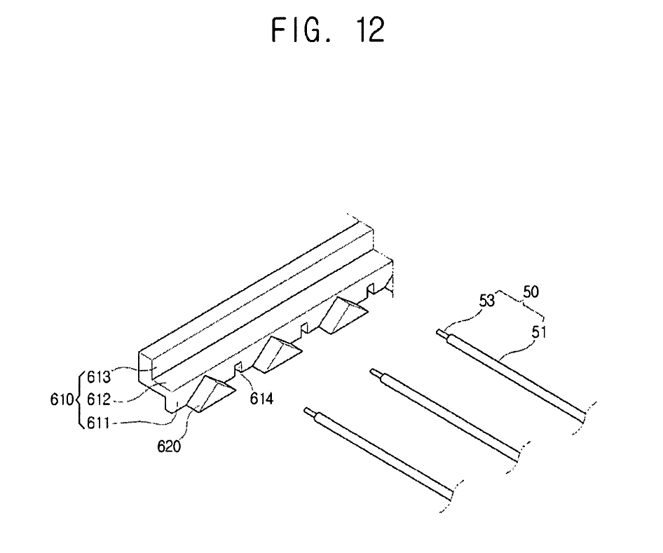

Referring to FIG. 12, the lamp electrode 53 of the lamp 50 is exposed to the outside. The lamp electrode 53 is connected to a power supplier (not shown) of a socket type which is disposed inside the accommodating mold 610.

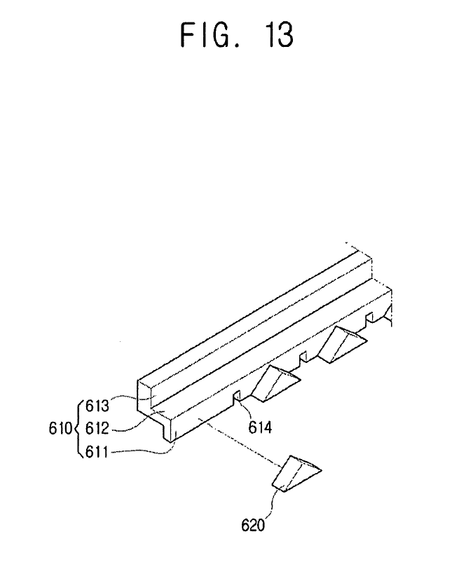

Referring to FIG. 13, the accommodating mold 610 and the protrusive reflecting part 620 are provided separately. The protrusive reflecting part 620 is assembled to the accommodating mold 610 and/or to the reflection plate 70.

As described above, embodiments of the present invention provides an LCD device in which brightness is uniform.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display (LCD) device comprising:
an LCD panel;
a light source disposed behind the LCD panel, the light source including a plurality of lamps disposed parallel with each other; and
a side mold including an accommodating mold to accommodate an end portion of the light source and a protrusive reflecting part disposed between adjacent lamps,
wherein the protrusive reflecting part protrudes toward the liquid crystal display panel.

2. The LCD device of claim 1, wherein the protrusive reflecting part faces a portion of the lamps.

3. The LCD device of claim 2, wherein a length of the protrusive reflecting part in a lengthwise direction of the lamps is about 5 mm to about 20 mm.

4. The LCD device of claim 1, wherein a length of the protrusive reflecting part in a transverse direction to the lengthwise direction of the lamps is about 85% to about 95% of an interval between the adjacent lamps.

5. The LCD device of claim 4, wherein a height of the protrusive reflecting part is about 26% to about 30% of the interval between the adjacent lamps.

6. The LCD device of claim 5, wherein the lamps are disposed in a position between about 20% and about 50% of the height of the protrusive reflecting part.

7. The LCD device of claim 5, wherein a cross section of the protrusive reflecting part in the transverse direction to the lengthwise direction of the lamps is bisymmetric.

8. The LCD device of claim 7, wherein the cross section of the protrusive reflecting part in the transverse direction to the lengthwise direction of the lamps has an isosceles triangle shape.

9. The LCD device of claim 7, wherein the cross section of the protrusive reflecting part in the transverse direction to the lengthwise direction of the lamps has a trapezodal shape.

10. The LCD device of claim 1, wherein the side mold comprises poly carbonate.

11. The LCD device of claim 1, wherein a height of the protrusive reflecting part decreases as a distance from the accommodating mold increases.

12. The LCD device of claim 1, wherein a length of the protrusive reflecting part in a transverse direction to the lengthwise direction of the lamps decreases as a distance from the accommodating mold increases.

13. An LCD device comprising:
an LCD panel;
a light source part disposed behind the LCD panel, the light source including a plurality of lamps disposed parallel with each other;
an accommodating mold accommodating an end portion of the light source part; and
a protrusive reflecting part disposed adjacent to the accommodating mold,
wherein the protrusive reflecting part is disposed between adjacent lamps, protrudes toward the LCD panel, and faces a portion of the lamps.

14. The LCD device of claim 13, wherein the accommodating mold and the protrusive reflecting part are integrated in a single body.

15. The LCD device of claim 14, wherein a length of the protrusive reflecting part in a lengthwise direction of the lamps is about 5 mm to about 20 mm.

16. The LCD device of claim 14, wherein a length of the protrusive reflecting part in a transverse direction to the lengthwise direction of the lamps is about 85% to about 95% of an interval between the adjacent lamps.

17. The LCD device of claim 16, wherein a height of the protrusive reflecting part is about 26% to about 30% of the interval between the adjacent lamps.

18. The LCD device of claim 17, wherein the lamps are disposed in a position between about 20% and about 50% of the height of the protrusive reflecting part.

19. The LCD device of claim 17, wherein a cross section of the protrusive reflecting part in the transverse direction to the lengthwise direction of the lamps is bisymmetric.

20. The LCD device of claim 19, wherein the cross section of the protrusive reflecting part in the transverse direction to the lengthwise direction of the lamps has an isosceles triangle shape.
